(19) United States
(12) Patent Application Publication
(10) Pub. No.: US 2024/0208427 A1
(43) Pub. Date: Jun. 27, 2024

(54) ROOF RACK SYSTEM

(71) Applicant: Danilo Gutierrez Liwanag, Layton, UT (US)

(72) Inventor: Danilo Gutierrez Liwanag, Layton, UT (US)

(21) Appl. No.: 18/225,302

(22) Filed: Jul. 24, 2023

Related U.S. Application Data
(60) Provisional application No. 63/367,127, filed on Jul. 25, 2022.

(51) Int. Cl. B60R 9/048; B60R 9/05

(52) U.S. Cl. CPC B60R 9/048; B60R 9/05

(57) ABSTRACT

The overhead roof rack storage system for a sport utility vehicle, automobile, and other types of vehicles is provided. The system includes a first bracket assembly, with a first elongated bracket, that is configured to be mounted to the vehicle in a first location, such as the front of the vehicle roof. The system further comprises a second bracket assembly, with a second elongated bracket, that is configured to be mounted to the vehicle in a second location. The system further includes a plurality of mounts configured to mount the second bracket assembly to the vehicle, and a storage rack, which may include a storage platform and a rail on each longitudinal end of the storage platform, including a first rail configured to engage the first elongated bracket and a second rail configured to engage the second elongated bracket.

### CROSS-REFERENCE TO RELATED APPLICATIONS

The present application claims the benefit of U.S. Provisional Application 63/367,127 having a filing date of Jul. 25, 2022, which is hereby incorporated by reference in its entirety.

### BACKGROUND OF THE APPLICATION

To provide additional storage space for an automobile or sport utility vehicle, many such vehicles include a roof rack, to which objects can be tied down to transport them during driving. But there are many shortcomings in the current state of the art for such roof racks. Roof racks are generally built into the vehicle prior to purchase and thus do not allow for flexibility in their dimensions, and the storage space is fixed in place. They also may lack barriers around the sides of the roof to help maintain the stored objects therein, and increasing the likelihood of objects sliding off the roof. Additionally, many vehicles may lack a roof rack entirely, and thereby require an external roof storage system to be attached, which can be bulky and unwieldy for a consumer to manage.

The present application seeks to address these and other shortcomings in the art by providing a novel roof rack storage system.

### SUMMARY OF THE APPLICATION

The system of the present application is an overhead roof rack storage system created for use with sports utility vehicles, or other automobiles and vehicles. The storage includes transportation of things like roof tents, camping equipment, gas tanks, rescue equipment, gear, etc., as an alternative to in-cab storage. The system is supported by front and rear mounts, along with a tower which provides rear support without placing weight on the vehicle roof.

The overhead roof rack storage system of the present application comprises various components, including a front bracket or rail assembly. The front bracket assembly comprises bent, rolled, fabricated aluminum and/or steel, or other materials, to form an arched bracket spanning a majority of the vehicle width. The assembly serves as the front mounting point for the basket or storage rack, which is secured with bolts, guides, end plates, and/or a locking pin. A further feature of the system and bracket assemblies is a stop plate on the end of a bracket, where the basket, which can include an approximately two-inch diameter aluminum tube fitting into the bracket, slides from the driver (or passenger) side of the assembly to the stop plate. At this point, the opposite end (passenger or driver side) can be fastened with a locking pin or indexing plunger. Along with rear bracket assembly, both ends will be secured to the basket to ensure stability.

The overhead roof rack storage system of the present application further includes two side tower mounts, which can be two machined brackets that mount onto the vehicle frame and rear quarter panels. These brackets can be fabricated from stainless steel or aluminum to provide rigidity and tensile strength to handle the weight of the tower. These may sit flush onto both sides of the vehicle frame (and rear quarter panels) and bolted down, and a ninety-degree angle (on each mount) can be provided as a sleeve for the tower to sit on, or they may take other forms such as a flat sheet or a stepped sheet. There is a plurality of bolts for each mount that fastens the tower onto the mount.

The overhead roof rack storage system of the present application still further includes a tower/rear bracket or rail assembly. The rear bracket assembly comprises bent, rolled, fabricated aluminum and/or steel, or other materials, to form an arched bracket spanning a majority of the vehicle width. The assembly is the rear mounting point for the basket/storage rack, which is secured with bolts, guides, end plates, and/or a locking pin. A further feature of the system and bracket assemblies is a stop plate on the end of a bracket, where the basket, which can include an approximately two-inch diameter aluminum tube fitting into the bracket, slides from the driver (or passenger) side of the assembly to the stop plate. At this point, the opposite end (passenger or driver side) can be fastened with a locking pin or indexing plunger. Along with the front bracket assembly, both ends will be secured to the basket to ensure stability.

The overhead roof rack storage system of the present application still further includes a multipurpose basket/rack, which can be designed with aluminum and spans the full length between both bracket assemblies. This is used for the storage and transportation of gear, supplies, etc. The basket may have a mounting system which slides from the passenger side to the driver's side. This assembly can be welded and attached to the tower, and may be an aluminum three-sided structure that spans over the cab/top of the vehicle. The horizontal side will have the bracket assembly, while the vertical sides may include a two-prong base which attach to each side tower mount. This full assembly will create the rear support for the rooftop storage system.

In an exemplary operational procedure: the front bracket assembly can be installed via top vehicle brackets using bolts (e.g., 10 mm bolts) and the side tower mounts can be installed using bolts (e.g., 18 mm bolts) into rear quarter panels through fastening points. Both mounts will protrude from the frame to create space to mount the tower. The tower mount can then be aligned with the installed mounts. A plurality of bolts on each side (e.g., three bolts) can be utilized to attach the mounts to the tower. The basket can then be lifted and aligned from the passenger (or driver) side. The basket will slide horizontally all the way to the driver (or passenger) side and press onto the stop plate. Once the basket is in position, a locking pin or indexing plunger can secure both brackets to the basket. Depending on the type of basket, additional locking pins may be necessary.

In accordance with an aspect of the present application, a system is provided. The system comprises a first bracket assembly, which may include a first elongated bracket and configured to be mounted to a vehicle in a first location. The system further comprises a second bracket assembly, which may include a second elongated bracket, and is configured to be mounted to the vehicle in a second location. The system further comprises a plurality of mounts configured to mount the second bracket assembly to the vehicle, and a storage rack, which may include a storage platform and a rail on each longitudinal end of the storage platform, including a first rail configured to engage the first elongated bracket and a second rail configured to engage the second elongated bracket.

Implementations of the system of the present application may include one or more of the following features. In various embodiments, the first bracket assembly of the system is configured to be mounted towards a front end of the vehicle and the second bracket assembly is configured to be mounted towards a rear end of the vehicle. Further, the first elongated bracket is configured to be disposed on a roof of the vehicle towards the front of the vehicle, and the second elongated bracket is configured to be disposed on the roof of the vehicle towards the rear of the vehicle.

In additional or alternative embodiments of the system of the present application, the second bracket assembly may further comprise two towers, wherein each of the towers may include a base comprising one or more mounting elements. The second bracket assembly may further comprise a cross rail disposed atop of and spanning the two towers, with the second elongated bracket mounted thereon.

In further additional or alternative embodiments of the system of the present application, each of the plurality of mounts may include: an inner segment comprising a plurality of mounting holes configured to receive bolts or screws that are configured to mount the inner segment to the vehicle, and an outer segment, which may include a plurality of further mounting holes configured to receive bolts or screws configured to mount the outer segment to one of the towers of the second bracket assembly.

In further additional or alternative embodiments of the system of the present application, Each of the plurality of mounts further may include a center segment, which may comprise one or more steps configured to offset the inner segment and the outer segment in height. The cross rail may include a plurality of through holes configured to receive bolts or screws configured to mount the second rail to the cross rail.

In further additional or alternative embodiments of the system of the present application, the first bracket assembly may include a fairing comprising an elongated section and a plurality of legs extending from the elongated section. The first bracket assembly may also include a plurality of fairing brackets, comprising a fairing bracket arranged on each end of the fairing adjacent to one of the plurality of legs. Each of the fairing brackets may include a base configured to mount to the vehicle, and a cutout configured to receive a portion of the first bracket.

In further additional or alternative embodiments of the system of the present application, the storage rack may include two opposing longitudinal beams and a plurality of cross beams arranged in between and perpendicular to the longitudinal beams, the longitudinal beams and the plurality of cross beams defining the storage platform of the storage rack.

In further additional or alternative embodiments of the system of the present application, the storage rack further may include a storage rack fairing arranged on each longitudinal end disposed in between the rail and the storage platform. Each rail of the storage rack may include a plurality of rails arranged adjacently. Each of the rails of the storage rack may also be configured to slide laterally within the first bracket and the second bracket to permit lateral movement of the storage rack. The first bracket and the second bracket each may include a stop member at one end to prevent lateral movement of the storage rack past the stop member.

In further additional or alternative embodiments of the system of the present application, each of the rails of the storage rack can be a cylindrical tube and the first and second brackets are each configured to receive a cylindrical tube. Each of the rails of the storage rack can be configured to snap into the first and second bracket to engage the rails within the first and second bracket. The storage rack further may include a vertical barrier on a plurality of sides of the storage platform to contain objects on the storage platform within the vertical barriers.

### BRIEF DESCRIPTION OF THE DRAWINGS

FIG. 1A shows a roof rack system for a vehicle in accordance with the present application;

FIG. 1B shows an exploded view of a roof rack system for a vehicle in accordance with the present application;

FIG. 2A shows a perspective view of a roof rack system for a vehicle in accordance with the present application;

FIG. 2B shows a side view of the roof rack system of FIG. 2A;

FIG. 2C shows a front end view of the roof rack system for a vehicle in accordance with the present application of FIG. 2A;

FIG. 2D shows a top view of a roof rack system for a vehicle in accordance with the present application of FIG. 2A;

FIG. 3A shows a top, perspective view of a storage rack for the roof rack system of FIG. 2A;

FIG. 3B shows a bottom, perspective view of the storage rack of FIG. 3A;

FIGS. 3C-3E show various views of a front roof rack fairing of the storage rack of FIG. 3A;

FIGS. 3G-3H show various views of a slide rail of the storage rack of FIG. 3A;

FIG. 4A shows a front, perspective view of a front bracket assembly for the roof rack system of FIG. 2A;

FIG. 4B shows a rear, perspective view of the front bracket assembly of FIG. 4A;

FIG. 4C-4E show various views of a front fairing bracket of the front bracket assembly of FIG. 4A;

FIGS. 4F-4H shows various views of a front bracket fairing of the front bracket assembly of FIG. 4A;

FIG. 5A shows a rear, perspective view of a rear bracket assembly of the roof rack system of FIG. 2A;

FIGS. 5B-5E show various views of a rear tower of the rear bracket assembly of FIG. 5A;

FIGS. 5F-5I show various views of a cross rail of the rear bracket assembly of FIG. 5A;

FIGS. 5J-5L shows various views of a rear bracket of the rear bracket assembly of FIG. 5A;

FIG. 5M shows various views of a back rail bracket of the rear bracket assembly of FIG. 5A;

FIG. 5N shows various views of a rail gusset of the rear bracket assembly of FIG. 5A;

FIG. 6A-6C shows various views of a rear mount of the roof rack system of FIG. 2A;

FIG. 7A shows a sliding roof rack assembly according to the present application;

FIG. 7B shows a connection between the storage rack and rear bracket assembly of the sliding roof rack assembly of FIG. 2B;

FIG. 7C shows a connection between the storage rack and front bracket assembly of the sliding roof rack assembly of FIG. 2B;

FIG. 8A shows a perspective view of a further rear bracket assembly of the system of the present application;

FIG. 8B shows a side view of a further rear bracket assembly of the system of the present application;

FIG. 8C shows a rear perspective view of a front bracket assembly of the system of the present application;

FIG. 8D shows a side view of the front bracket assembly of FIG. 10a;

FIG. 8E shows a front perspective view of the front bracket assembly of FIG. 10a;

FIGS. 9A-9C show a further roof rack system according to the present application;

FIGS. 10A-10C show a further front bracket assembly according to the present application;

FIG. 11 shows a further front and rear bracket assembly according to the present application;

FIG. 12 shows a further front and rear bracket assembly according to the present application;

FIG. 13 shows a further front and rear bracket assembly according to the present application;

FIG. 14A shows a first embodiment of a storage rack according to the present application;

FIG. 14B shows a second embodiment of a storage rack according to the present application; and

FIG. 14C shows a third embodiment of a storage rack according to the present application; and

FIGS. 15A-15B show the roof rack system of FIG. 2A further comprising an attached rear storage assembly.

### DETAILED DESCRIPTION OF THE FIGURES

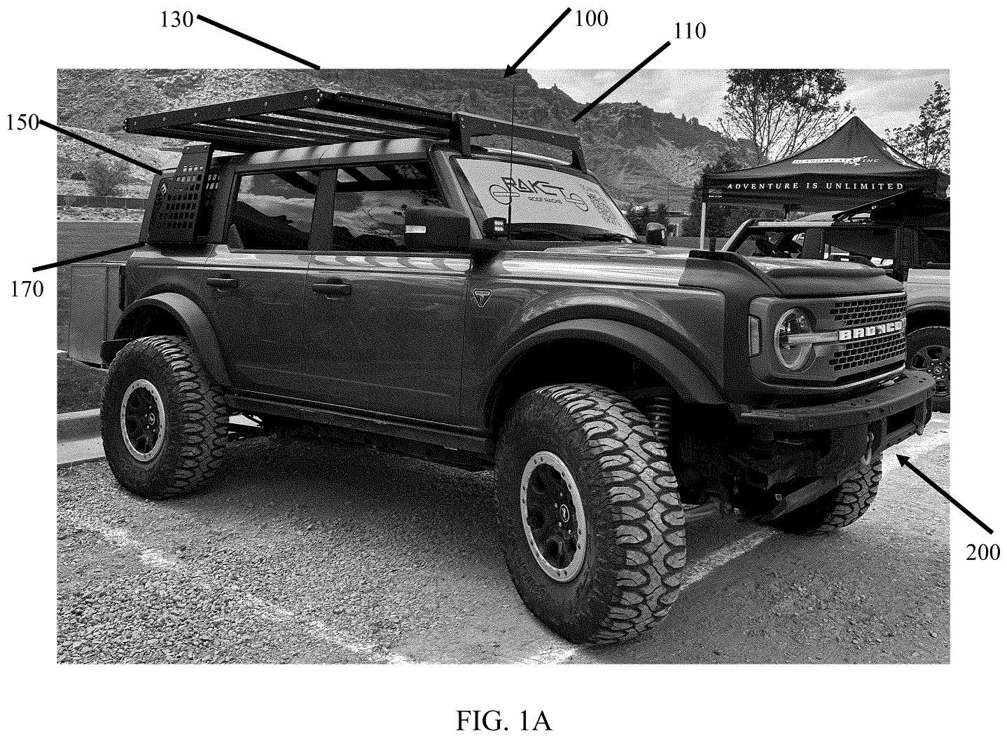

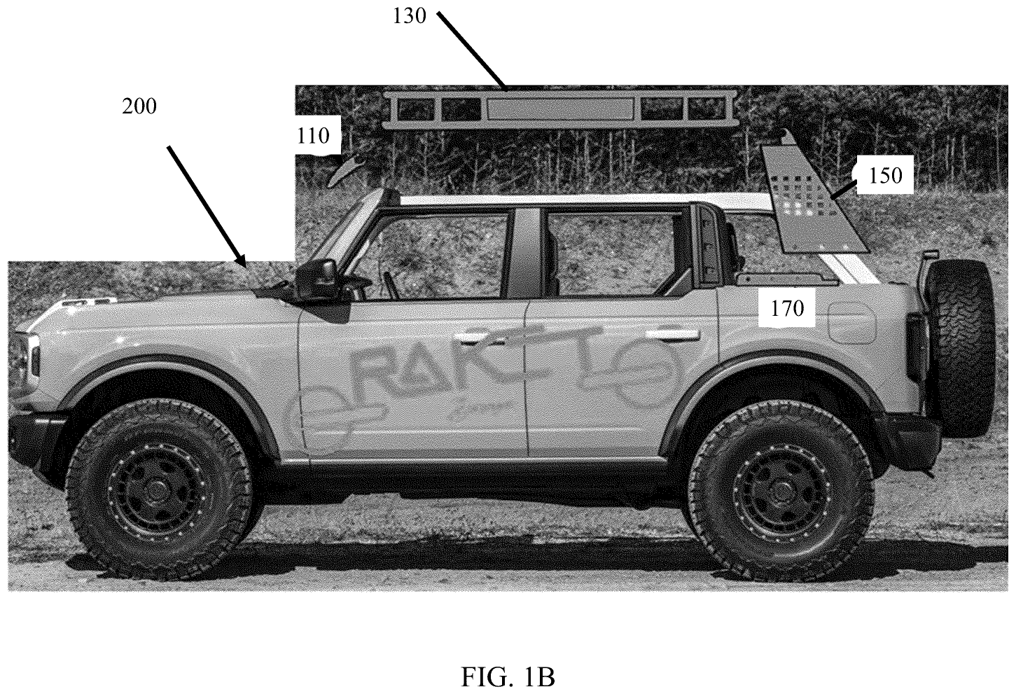

The system of the present application will now be described with reference made to FIGS. 1A-15B.

The present application relates to an overhead roof rack storage system 100 created for use with an automobile or vehicle 200, such as a sport utility vehicle (SUV). The storage system 100 is an external device secured to the vehicle 200, and allows for the transportation of objects such as roof tents, camping equipment, gas tanks, rescue equipment, gear, etc., atop the roof of a vehicle lacking an appropriate roof storage, or as an alternative to in-cab storage.

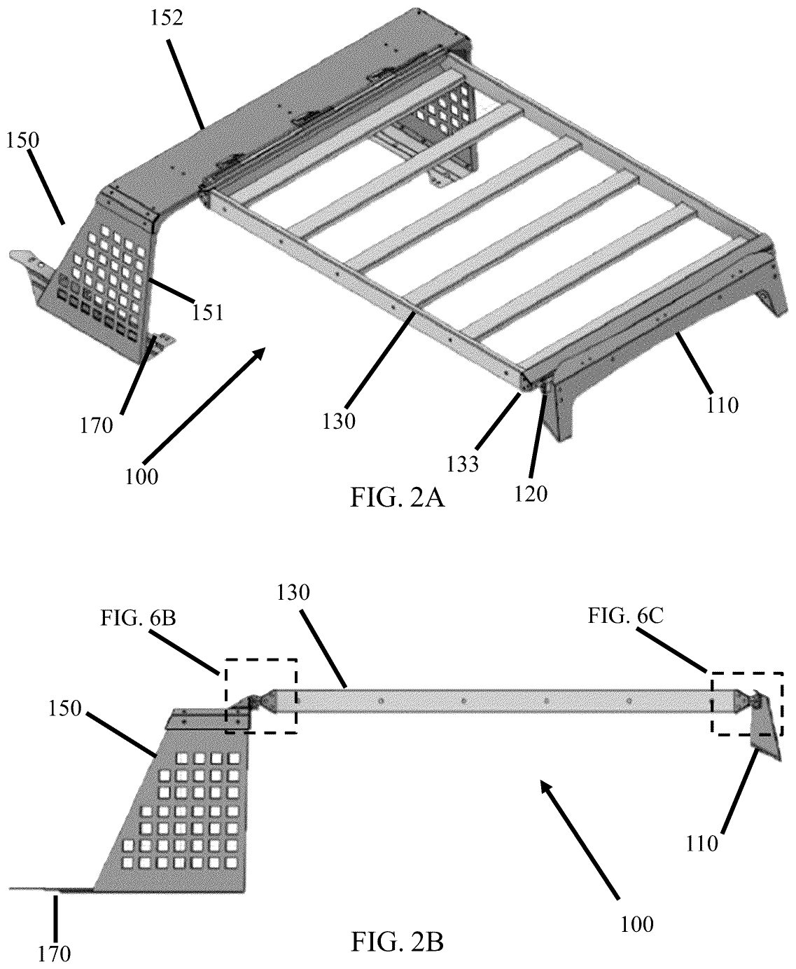

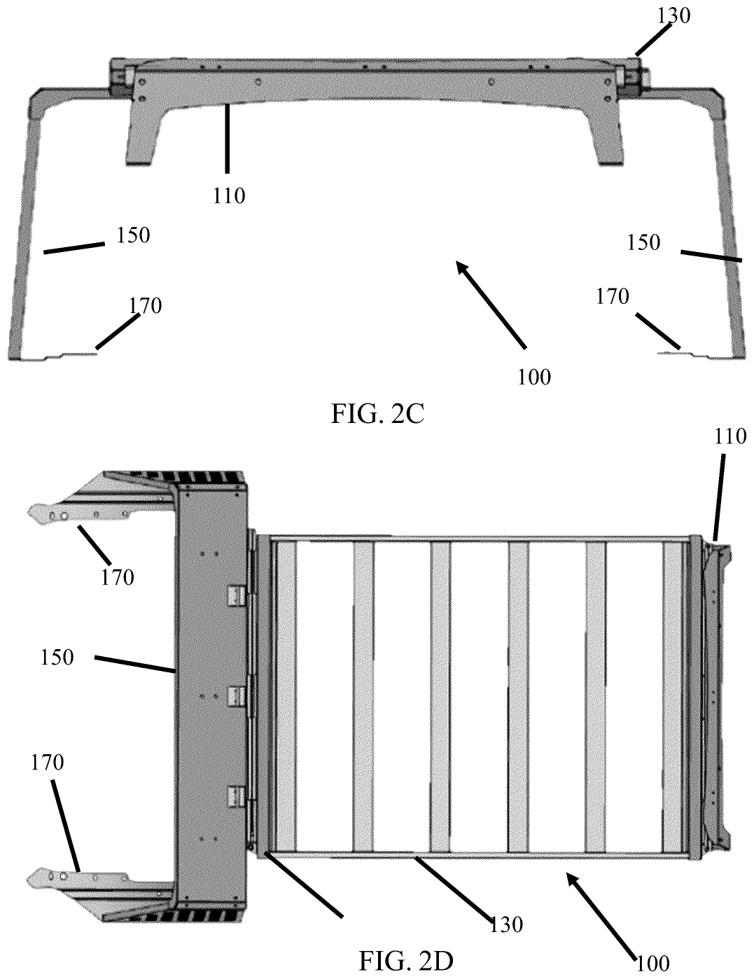

The storage system 100 of the present application comprises several elements, including four components: a front bracket assembly 110, a storage rack 130, a rear bracket assembly 150, and a pair of rear mounts 170. As shown for example in FIGS. 1A-1B, the front bracket assembly 110 is secured to the top or the roof of the vehicle 200, and is positioned above the windshield. A rear mount 170 is arranged on each side of the vehicle 200, such as at the base of a rear side window or atop a cab, and the rear bracket assembly 150 is affixed to each of the rear mounts 170. The storage rack 130 is arranged in between and secured to the front bracket assembly 110 and the rear bracket assembly 150, over the vehicle 200. In the embodiment of the storage system 100 shown in FIGS. 1A and FIGS. 2A-2D, the storage rack 130 and the front bracket and rear bracket assemblies 110, 150 are constructed so as to enable the sliding of the storage rack 130 on and off of the roof of the vehicle 200. But other constructions of the storage system 100 may be provided which comprise different mechanisms for connecting the storage rack 130 to the front bracket and rear bracket assemblies 110, 150, as discussed further herein.

FIGS. 2A-2D show a storage system 100 according to an aspect of the present application, comprising a front bracket assembly 110 secured to a front end of a storage rack 130. The storage system 100 comprises a rear bracket assembly 150, secured to a rear end of the storage rack 130. The rear bracket assembly 150 comprises two opposing towers 151 and a cross rail 152. The rear end of the storage rack 130 is secured to the cross rail 152, and base of each of the towers 151 is secured to a rear mount 170, which are configured to secure the rear bracket assembly 150 to the vehicle.

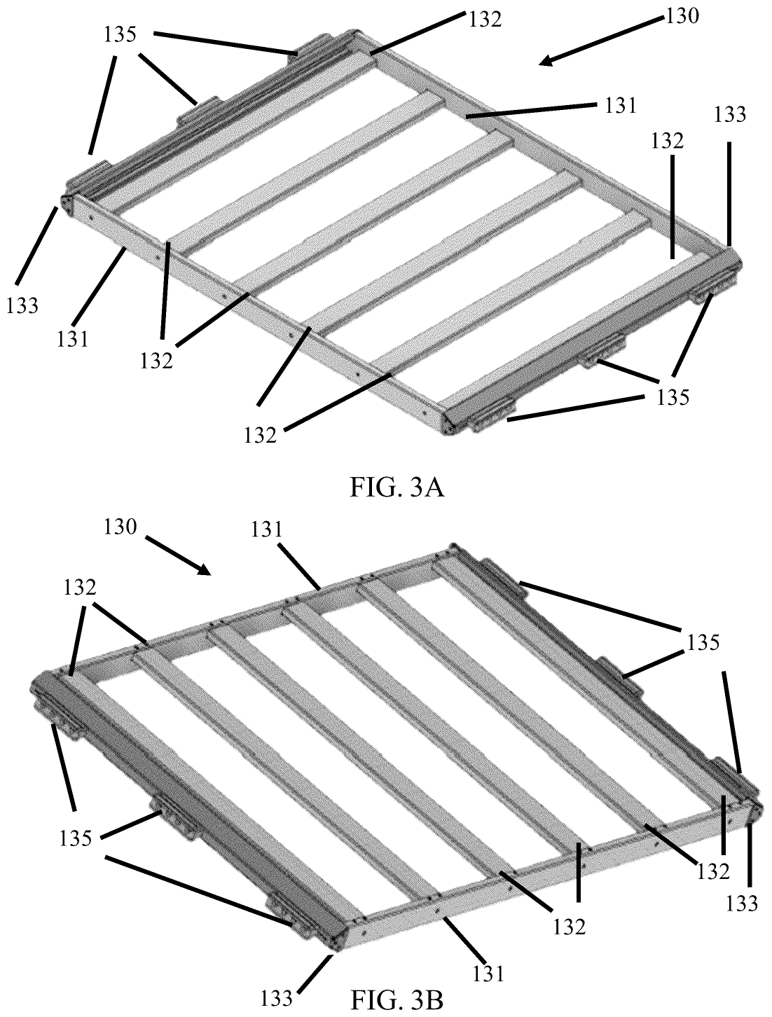

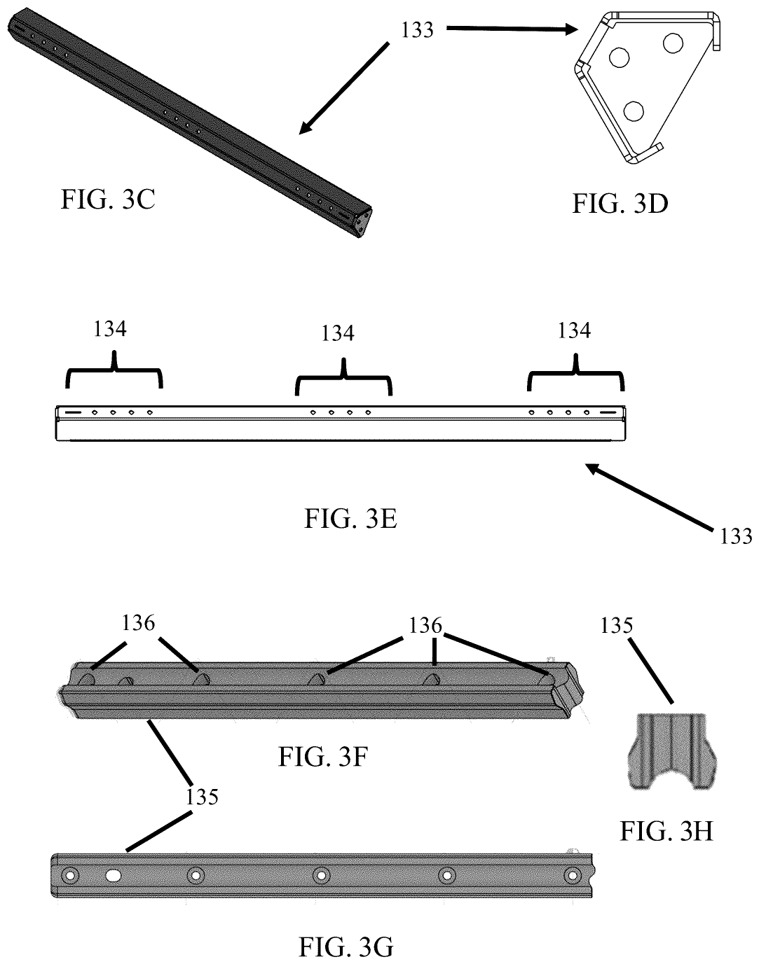

Features of the storage rack 130, front bracket assembly 110, rear bracket assembly 150, and rear mounts 170 are shown in further detail in FIGS. 3A-7C, and described below.

The storage rack 130 may comprise two longitudinal beams 131 spanning its length on opposing sides of the storage rack 130. A series of cross beams 132 are arranged in between and perpendicular to the two longitudinal beams 131, and are affixed to the longitudinal beams 131, to form a surface upon which objects can be placed. In the storage rack 130 shown in FIGS. 3A-3B, six cross beams 132 are provided, but in other embodiments, this number may vary to be greater or less than six, and in other embodiments, the cross beams 132 may be replaced by a platform or surface. Further in the storage rack 130 shown in FIGS. 3A-3B, the cross beams 132 are disposed between the longitudinal beams 131 in such a manner that a bottom surface of the cross beams 132 is substantially flush with a bottom surface of the longitudinal beams 131 (FIG. 3B) and a top surface of the cross beams 132 is disposed beneath a top surface of the longitudinal beams 131 (FIG. 3A). But this arrangement may be reversed in other embodiments, or the cross beams 132 can be located substantially centrally relative to the longitudinal beams 131, or substantially the same width, to be flush on the top and bottom.

The storage rack 130 may comprise a fairing 133 on either or both ends. The fairing 133 may be secured to one or more of the ends of the longitudinal beams 131, and the frontmost and/or rearmost cross beam(s) 132. As shown for example in FIGS. 3C-3D, the fairing 133 may have a substantially trapezoidal cross-section. The fairing 133 also comprises a plurality of holes 134 along its length, which are used in securing the fairing 133 to one or more slide rails 135, having a corresponding plurality of through holes 136. The slide rails 135 are configured to enable the storage rack 130 to slide onto the front bracket assembly 110 and rear bracket assembly 150, as described in further detail below. The through holes 136 of the slide rails 135 align with the holes 134 of the fairing 133, and are configured to receive screws or bolts therethrough to secure the slide rails 135 to the fairing 133.

Although FIGS. 3A-3B show the storage rack 130 comprising three slide rails 135 on each of the two fairings 133, it is noted that this number may differ in other embodiments, and the storage rack 130 may alternatively comprise one, elongated rail as opposed to a series of shorter rails as shown in the Figures. Alternatively, the storage rack 130 may comprise the slide rail(s) 135 secured directly to the longitudinal beams 131 and/or the frontmost and/or rearmost cross beam(s) 132, without fairings 133 being provided. Still further alternatively, the slide rails 135 can be replaced with tubes that may snap or fit into a bracket or channel on the front and rear assemblies, or other non-sliding connecting mechanisms can be provided. In additional embodiments of the storage rack 130, elevated walls or barriers can be provided around the perimeter to make the storage rack 130 basket-like, to maintain the objects placed thereon within the perimeter barriers.

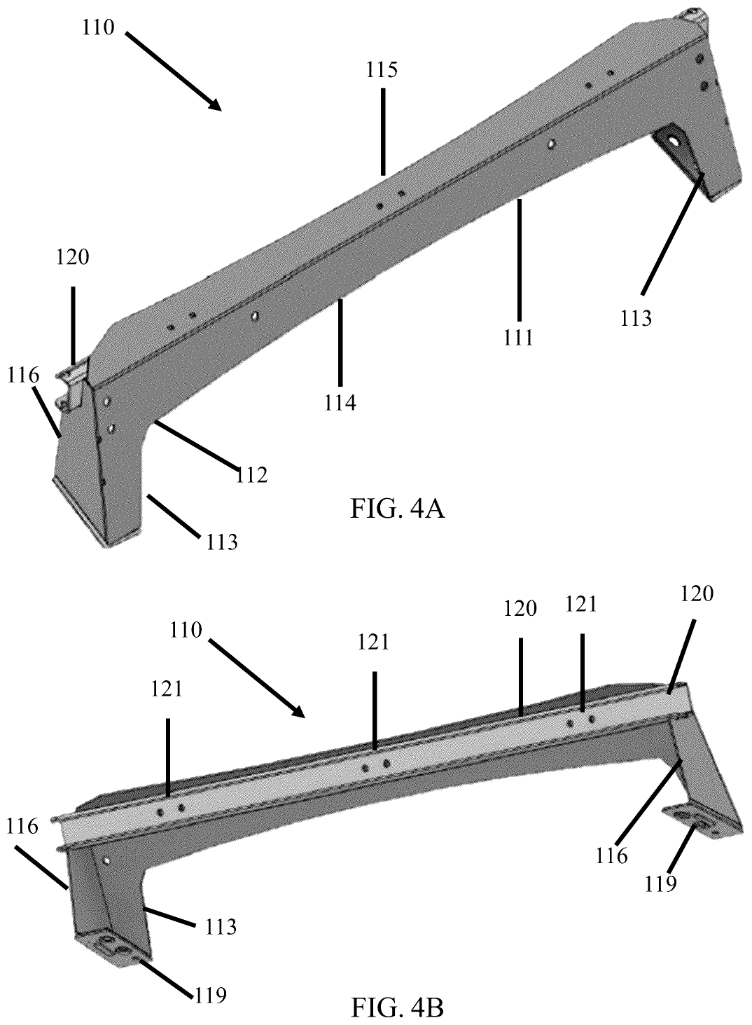

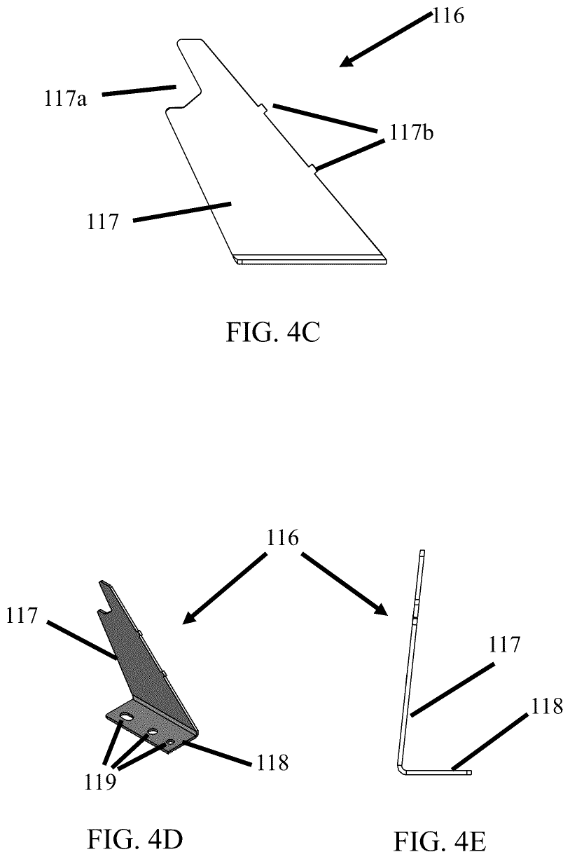

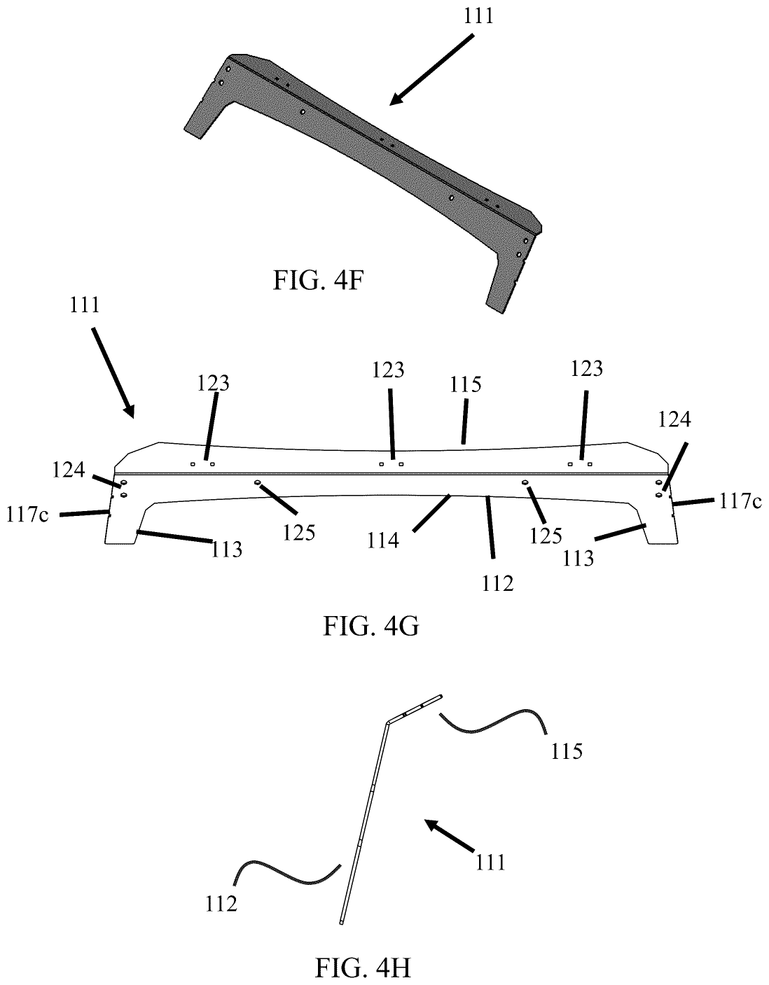

The front bracket assembly 110 is secured to the front of the vehicle 200 and is configured to serve as a front mounting point for the storage rack 130. The front bracket assembly 110 of the storage system 100 of FIG. 2A-2D and elements thereof are shown in further detail in FIGS. 4A-4H.

The front bracket assembly 110 illustrated in FIGS. 4A-4H comprises a front bracket fairing 111 with a front fairing bracket 116 arranged on each end. The front bracket assembly 110 further comprises a front bracket 120 spanning the length of the front bracket assembly 110. The front bracket 120 is configured to receive the slide rails 135 of the storage rack 130 thereon for connecting the storage rack 130 to the front bracket assembly 110.

As shown in the Figures, particularly FIGS. 4A-4B and 4F-4H, the front bracket fairing 111 comprises a fairing lower segment 112 and a fairing upper segment 115. The lower and upper segments 112, 115 may be separated by an angle greater than ninety-degrees, as shown in FIG. 4H, which shows an example in which the lower and upper segments 112, 115 form an angle of one hundred and thirty-degrees, although the angle may vary in other embodiments of the front bracket fairing 111. The fairing lower segment 112 includes lower segment legs 113 on each end and an elongated section 114 therebetween. The fairing upper segment 115 is also elongated, and extends from the elongated section 114 of the fairing lower segment 112.

The front bracket assembly 110 further includes a front fairing bracket 116 arranged on each end of the front bracket fairing 111, which is shown for example in FIGS. 4C-4E. Each front fairing bracket 116 includes an upper segment 117 and a lower segment 118. The upper segment 117 is a substantially flat surface, and includes a cut out 117a, which is configured for receiving the front bracket 120 therein, supporting the front bracket 120 on each end of the front bracket assembly 110. The upper segment 117 also includes an elongated edge, opposite an edge having the cutout 117a, which is angled such that in combination with an upper edge of the upper segment 117, the upper segment 117 fits into the angle formed in between the fairing lower segment 112 and fairing upper segment 115. The elongated edge of the front fairing bracket 116 upper segment 117 may comprise one or more tabs 117b configured to engage corresponding notches 117c on the front bracket fairing 111 to aid in connecting the two components. In the embodiment shown in the Figures, the lower segment 118 of the front fairing bracket 116 is separated from the upper segment 117 by an acute angle, and has an edge that abuts the base of a lower segment leg 113 of the front bracket fairing 111. The lower segment 118 comprises a plurality of mounting holes 119 used in mounting the front bracket assembly 110 to the front of the vehicle 200.

The front bracket assembly 110 further comprises a front bracket 120 spanning its length, and which comprises a channel configured to receive a slide rail 135 of the storage rack 130 in a manner that allows the slide rail(s) 135 to slide laterally through the front bracket 120. The front bracket 120 includes a plurality of mounting holes 121 along its length used in securing the front bracket 120 to the front bracket fairing 111. The front bracket fairing 111 also comprises mounting holes 123 in the fairing upper segment 115 and mounting holes 124, 125 in the fairing lower segment 112. Bolts and/or screws can be provided for use with the mounting holes to secure the components together.

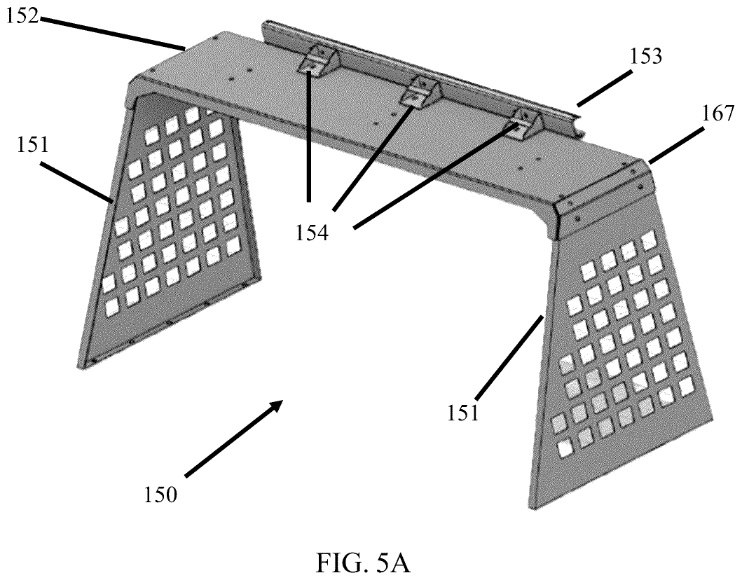

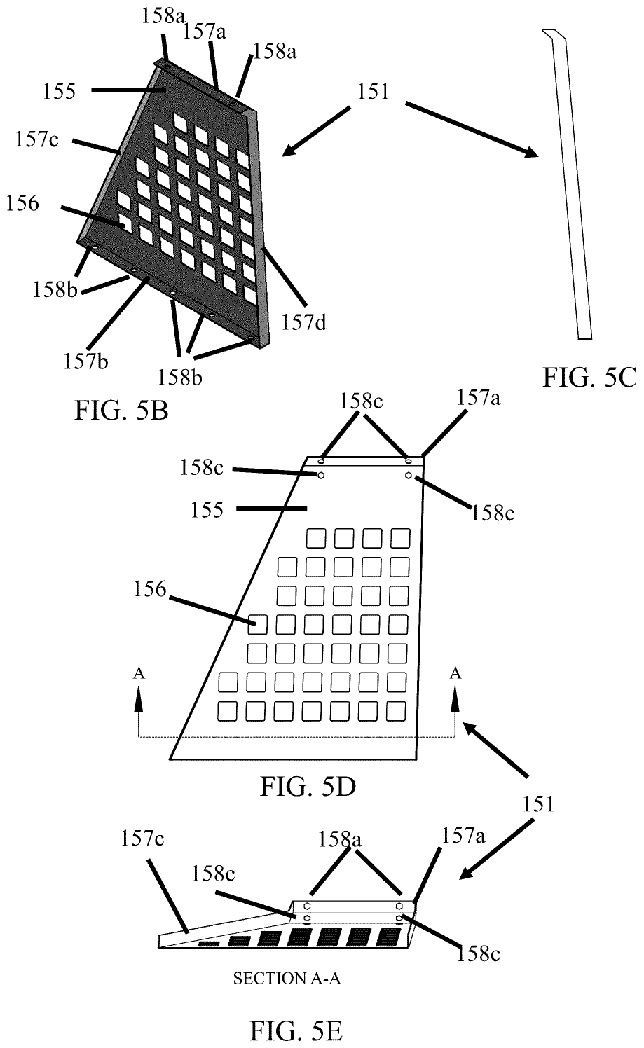

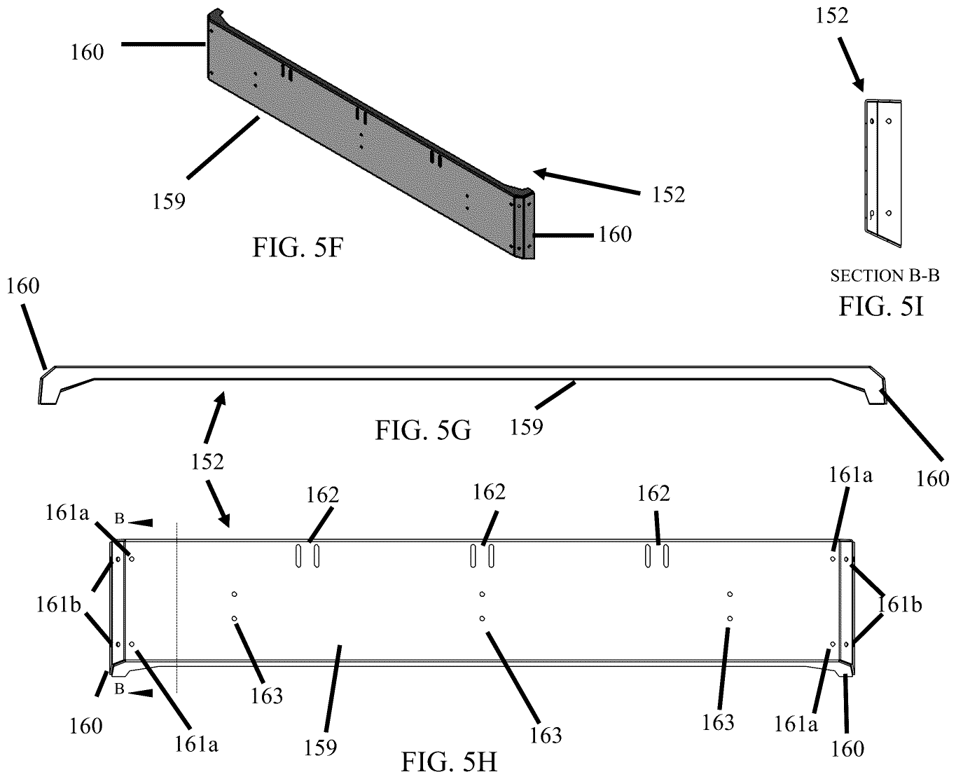

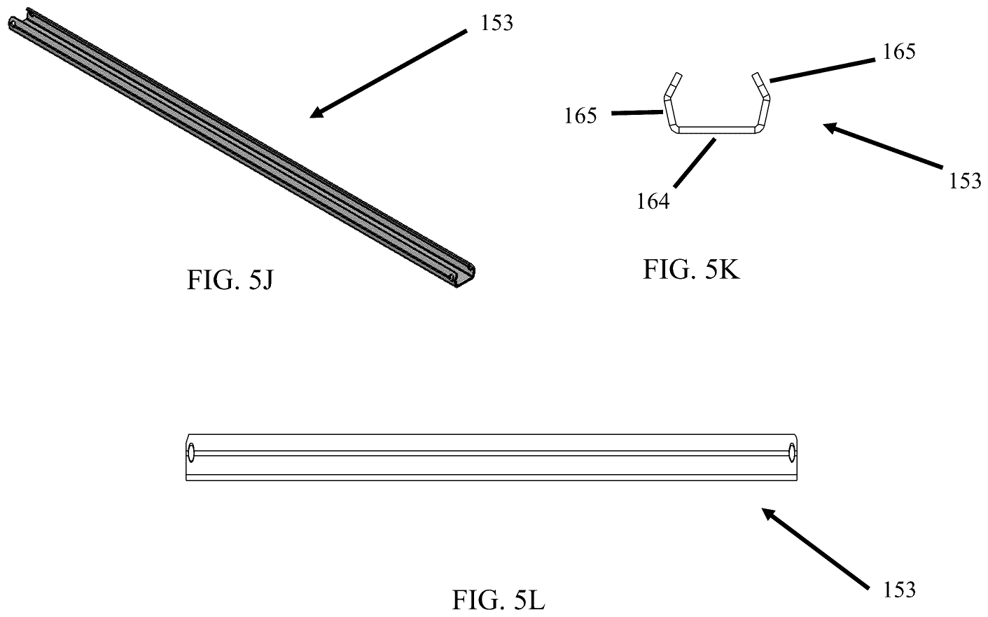

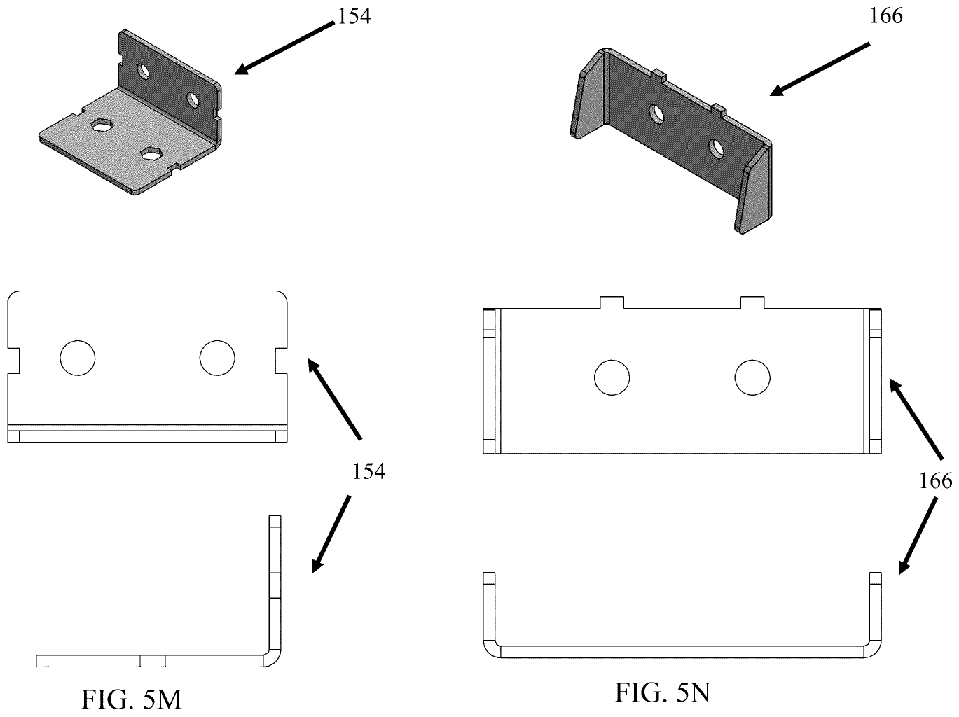

The rear bracket assembly 150 is secured to the rear of the vehicle 200 and is configured to serve as a rear mounting point for the storage rack 130. The rear bracket assembly 150 of the storage system 100 of FIG. 2A-2D and elements thereof are shown in further detail in FIGS. 5A-5N.

The rear bracket assembly 150 illustrated in FIGS. 5A-5N comprises a pair of towers 151, one on each side of the rear bracket assembly 150, and a cross rail 152 spanning the two towers 151. The rear bracket 153 is mounted to the cross rail 152 by a plurality of mounting brackets 154. The rear bracket 153 is configured to receive a slide rail 135 of the storage rack 130 thereon for connecting the storage rack 130 to the rear bracket assembly 150, and allowing the slide rail(s) 135 to slide through the rear bracket 153.

A tower 151 of the rear bracket assembly 150 is shown in FIGS. 5B-5E. The tower 151 comprises a tower surface 155 surrounded by a plurality of walls 157a, 157b, 157c, 157d projecting therefrom. In the embodiment shown in FIGS. 5B-5E, the tower surface 155 is trapezoidal, but the shape may vary in other embodiments of the tower 151. Further in the embodiment shown in FIGS. 5B-5E, the tower surface 155 includes a mesh 156 formed thereon including a plurality of openings through the surface arranged in a grid. However, other embodiments of the tower 151 may omit this mesh 156, or have a different arrangement of openings through the tower surface 155. The upper wall 157a of the tower 151 includes a plurality of through holes 158a used in connecting the tower 151 to the cross rail 152, and the lower wall 157b also includes a plurality of through holes 158b used in connecting the tower 151 to the rear mount 170. An upper portion of the tower surface 155 may also comprise one or more sets of through holes 158c, which may also be used in connecting the tower 151 to the cross rail 152.

The cross rail 152 of the rear bracket assembly 150 comprises an elongated beam 159 having two bent or curved end portions 160. The end portions 160 are shaped to substantially match the bending or curvature at the top of the tower 151. The end portions 160 of the cross rail 152 may comprise a first set of upper through holes 161a, which are arranged to align with the through holes 158a on the upper wall 157a of the tower 151. The end portions 160 of the cross rail 152 may also comprise one or more sets of lower through holes 161b, which are arranged to align with the one or more sets of through holes 158c on the tower 151. The various aligning through holes of the towers 151 and cross rail 152 may receive nuts and bolts, or other connecting elements therethrough in order to connect the towers 151 and cross rail 152, as shown for example in FIG. 5A. Additionally, a separate connector bracket 167 can be provided to further strengthen the connection of the towers 151 and cross rail 152.

The elongated beam 159 of the cross rail 152 is dimensioned in length to substantially span the width of a vehicle 200 and comprises a flat surface for mounting the rear bracket 153. A plurality of through holes 162 are dispersed along the length of the elongated beam 159 for connecting mounting brackets 154 to the cross rail 152. The mounting brackets 154 have aligning through holes for receiving nuts or screws that connect the mounting brackets 154 to the elongated beam 159. The elongated beam 159 may also include additional through holes 163 for connecting other components to the rear bracket assembly 150, or for positioning the rear bracket 153 in a different location to accommodate a storage rack of a different length.

The rear bracket 153 comprises a channel configured for receiving the slide rails 135 of the storage rack 130 for connecting the storage rack 130 to the rear bracket assembly 150. As shown for example in FIG. 5K, along the length of the rear bracket 153, a cross-sectional profile including a bottom surface 164 and with two side walls 165 is provided, with an opening in between for receiving the slide rail 135. The bottom surface 164 of the rear bracket 153 includes a plurality of through holes that are used for securing the rear bracket 153 to the mounting brackets 154 by a plurality nuts and bolts. Rail gussets 166 may also be utilized in combination with the mounting brackets 154. It is noted that the configuration of the front bracket 120 may be the same as that of the rear bracket 153.

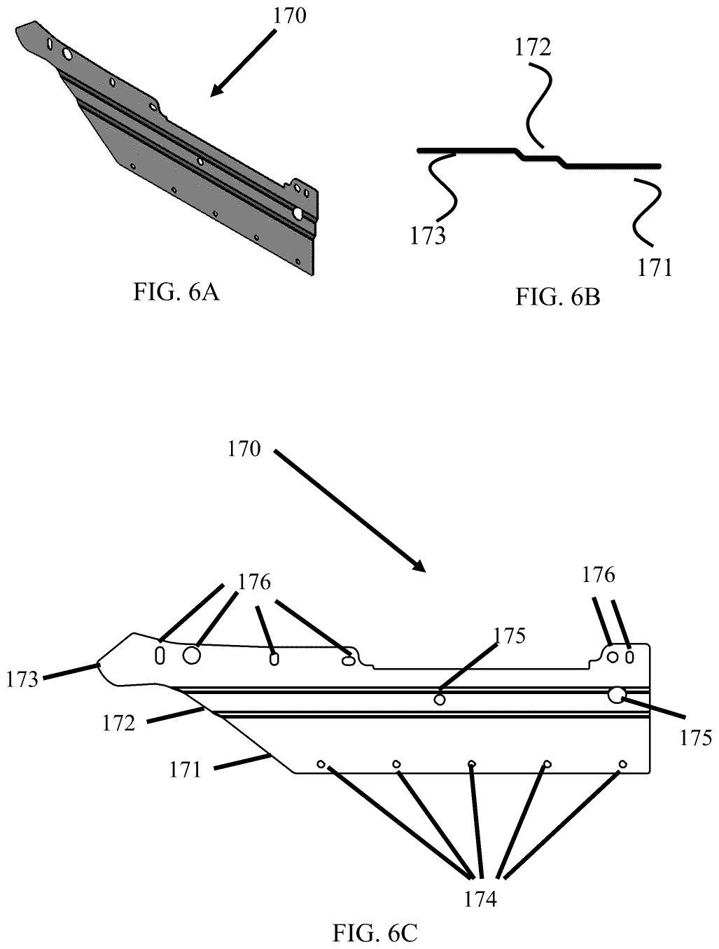

The storage system 100 further comprises a pair of rear mounts 170, which are configured to be mounted to the vehicle 200 and to the towers 151 of the rear bracket assembly 150 to secure the rear bracket assembly 150 to the rear of the vehicle 200. A rear mount 170 of the storage system 100 of FIG. 2A-2D and elements thereof are shown in further detail in FIGS. 6A-6C.

In the embodiment shown in FIGS. 6A-6C, the rear mount 170 includes three sections along the width of the rear mount 170: an outer segment 171, a center segment 172, and an inner segment 173. The outer segment 171 comprises a plurality of through holes 174, which are configured to align with the through holes 158b of a tower 151, and are used in connecting one of the towers 151 of the rear bracket assembly to the rear mount 170. The inner segment 173 also comprises a plurality of through holes 176, which are used in connecting the rear mount 170 to the vehicle 200. The center segment 172 is arranged in between the outer segment 171 and the inner segment 173, and may also comprise through holes 175 used in connecting the rear mount 170 to the vehicle. In the embodiment of the rear mount 170 shown in FIGS. 6A-6C, the center segment includes a plurality of steps, such that the inner segment 173 is elevated in height relative to the outer segment 171. In the rear mount 170 shown in FIG. 6B, the steps are formed at a forty five-degree angle from the outer and inner segments 171, 173, but in other embodiments, the steps may be formed at angles greater or less than forty five-degrees, or may be omitted such that the rear mount 170 is substantially flat. In other embodiments, such as that shown in FIG. 1B, the outer segment 171 of the rear mount 170 may be substantially perpendicular or non-planar relative to the inner segment 173, so that the rear mount 170 can accommodate a tower 151 having connecting through holes on the surface 155 of the tower 151, or both the inner segment 173 and outer segment 171 are perpendicular to the center segment 172.

For use of the storage system 100 with a vehicle 200, the front bracket assembly 110 is mounted to the front of the vehicle 200. In the embodiment illustrated in FIG. 1A, the front bracket assembly 110 is mounted to the vehicle 200 above the front windshield by bolting the lower segment 118 of the front fairing bracket 116 to the vehicle 200 through the mounting holes 119. Each of the two rear mounts 170 are mounted onto the vehicle frame and/or rear quarter panels of the vehicle 200 by way of bolts through the through holes 176 on the inner segment 173 of the rear mount 170. The rear bracket assembly 150 can then be bolted onto the rear mounts 170, by connecting each of the two towers 151 of the rear bracket assembly 150 to the rear mounts 170 as previously described. It is noted that the rear bracket assembly 150, including two towers 151 and cross rail 152 with rear bracket 153, can be installed onto the rear mounts 170 as a preassembled unit, or the two towers 151 can be installed onto the rear mounts 170 separately and the cross rail 152 attached to the two towers 151 thereafter.

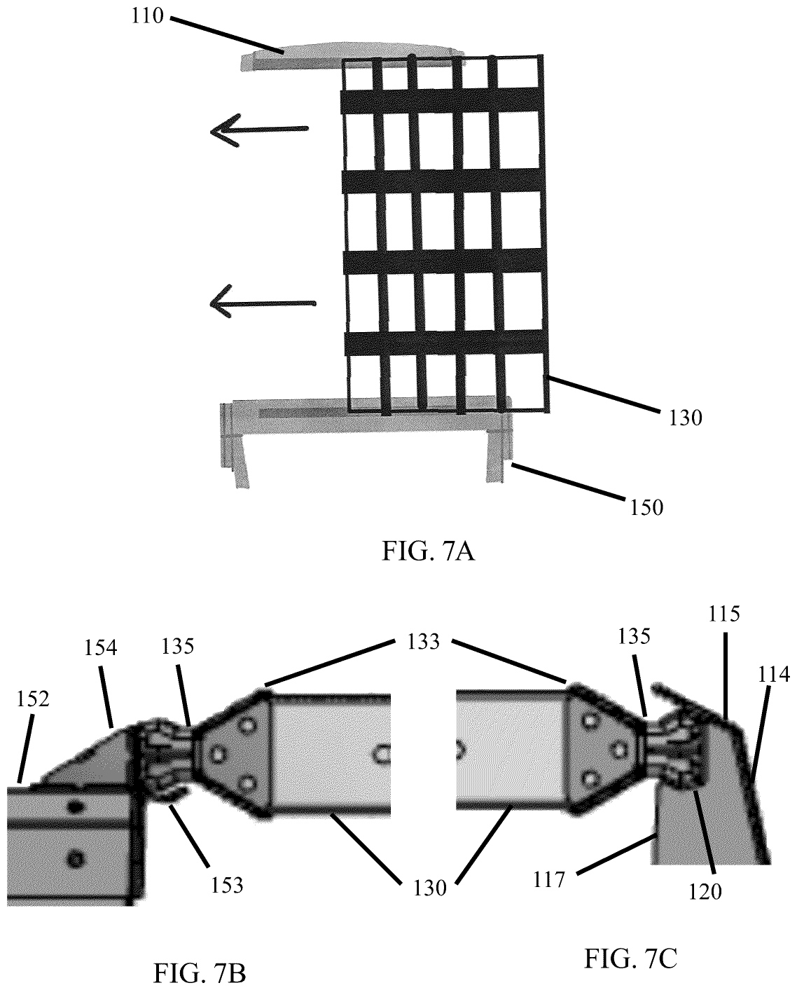

Once the front bracket assembly 110 and the rear bracket assembly 150 are installed on the vehicle 200, the storage rack 130 can slide onto the storage system 100, as shown for example in FIG. 7A. The storage rack 130 comprises a slide rail 135 on each longitudinal end of the storage rack 130, as previously described. In the front end of the storage system 100, a slide rail 135 slides into the front bracket 120 of the front bracket assembly 110, and in the rear end of the storage system 100, a slide rail 135 slides into the rear bracket 153 of the rear bracket assembly 150. The front bracket assembly 110 and rear bracket assembly 150 of the storage system 100 can be installed onto the vehicle 200 in such a manner that the storage rack 130 can be easily slid out of the storage system 100 and stored separately when it is not in use, and slid back onto the storage system 100 for use.

The front bracket 120 and rear bracket 153 may each be configured with a vertical stop member on one end of the brackets 120, 153, which are configured to stop the storage rack 130 from sliding off of the storage system 100. For example, the front bracket 120 and rear bracket 153 may comprise vertical stop members on the ends corresponding to driver's side of the installed storage system 100, allowing the storage rack 130 to be slid onto and off of the storage system 100 from the passenger side, but this may be reversed. The storage system 100 may also comprise a storage rack 130 locking mechanism, which prevents the storage rack 130 from sliding after it is installed.

Although the storage system 100 of the present application has been described with reference to a configuration or embodiment shown in FIGS. 2A-7C, it is noted that the storage system may comprise alternative configurations without departing from the scope of the present application.

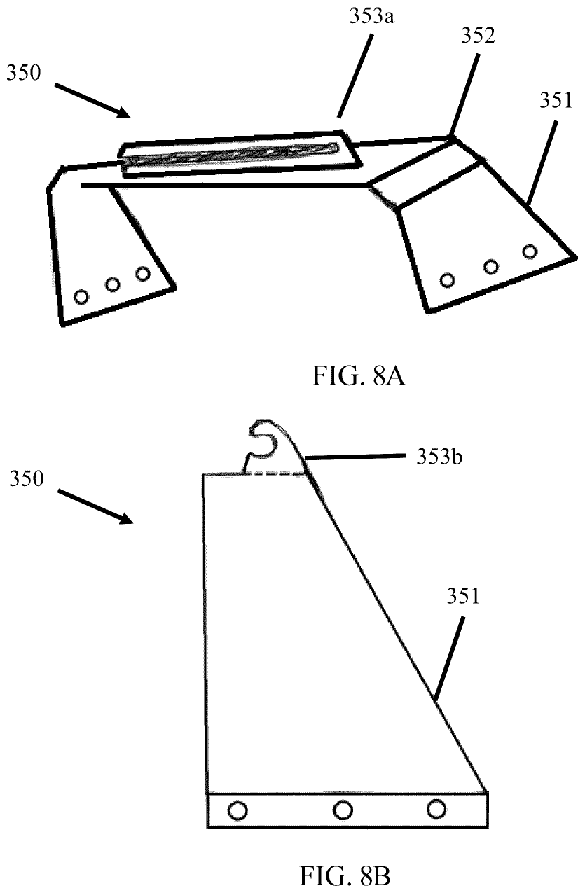

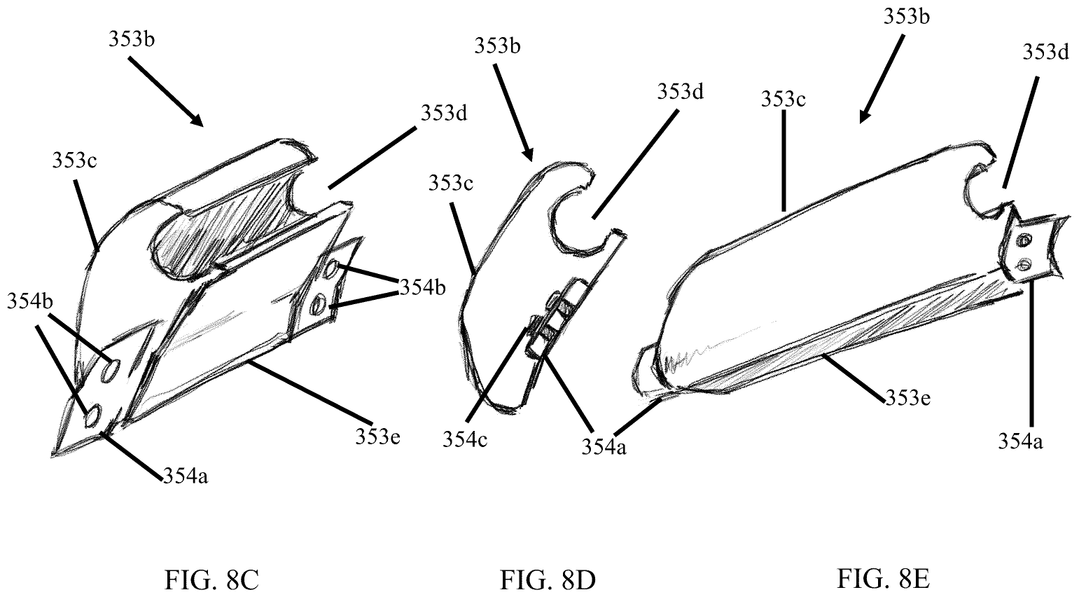

FIG. 8A shows a storage system comprising a rear bracket assembly 350 comprising a cylindrical bracket 353a for a storage rack comprising cylindrical tubes or rails at each end, instead of comprising slide rail 135 as previously described. In such a storage system, the storage rack is provided with a cylindrical rail at each longitudinal end. The rear bracket assembly 350 comprises a pair of towers 351 and cross rail 352, which may be constructed similarly to the towers 151 and cross rail 152 previously described, or may have variations such as shown in FIG. 8A which omits a mesh 156 and includes mounting holes for the rear mounts on the tower surface. The cylindrical bracket 353a is provided on the cross rail 352 and is configured such that a cylindrical rail or tube of a storage rack can be snapped into the bracket 353a and locked into place, rather than slid on and off of the rear bracket assembly 350.

In a further variation of the rear bracket assembly 350 shown in FIGS. 8B-8E, the cylindrical bracket 353b can be a separable component from the cross rail 352 that can be attached to and removed from the rear bracket assembly 350. The bracket 353b comprises a body 353c and an open channel 353d, which is configured to receive a cylindrical rail of a storage rack. At the base 353e of the body 353c and on each end, a mount 354a can be provided, which comprises a plurality of through holes 354b configured to receive a plurality of bolts or screws 354c, for securing the bracket 353b to the cross rail 352. The cross rail 352 may comprise corresponding through holes, such as the through holes 162, 163 of the previously described cross rail 152, for connecting the bracket 353b. The cross rail 352 may also be configured in the same manner as the previously described cross rail 152, wherein the through holes 162 are used for positioning a rear bracket 153 or bracket 353b in one location a first distance from the front bracket assembly, and the through holes 163 are used for positioning a rear bracket 153 or bracket 353b in one location a second distance from the front bracket assembly, for accommodating use of the storage system 100 with storage racks of different sizes. Although a corresponding front bracket assembly is not shown in combination with the rear bracket assembly 350 in FIGS. 8A-8E, it is to be understood that a corresponding front assembly with a similarly constructed cylindrical bracket or channel for receiving a cylindrical tube on the front end of the storage rack is also provided.

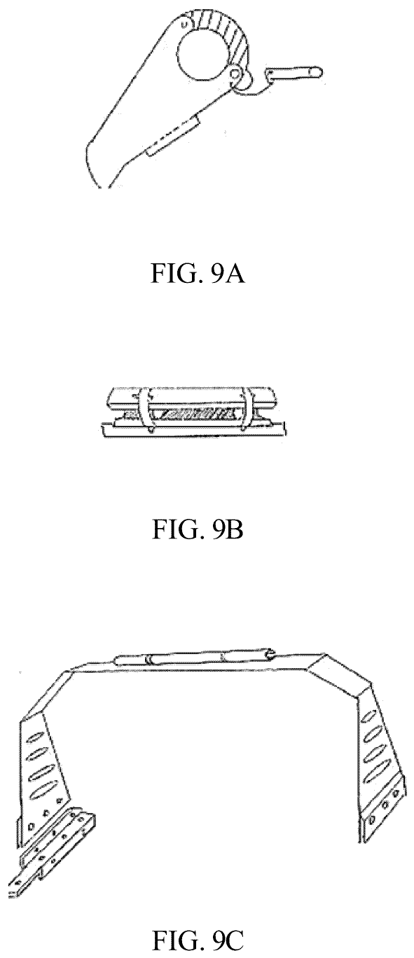

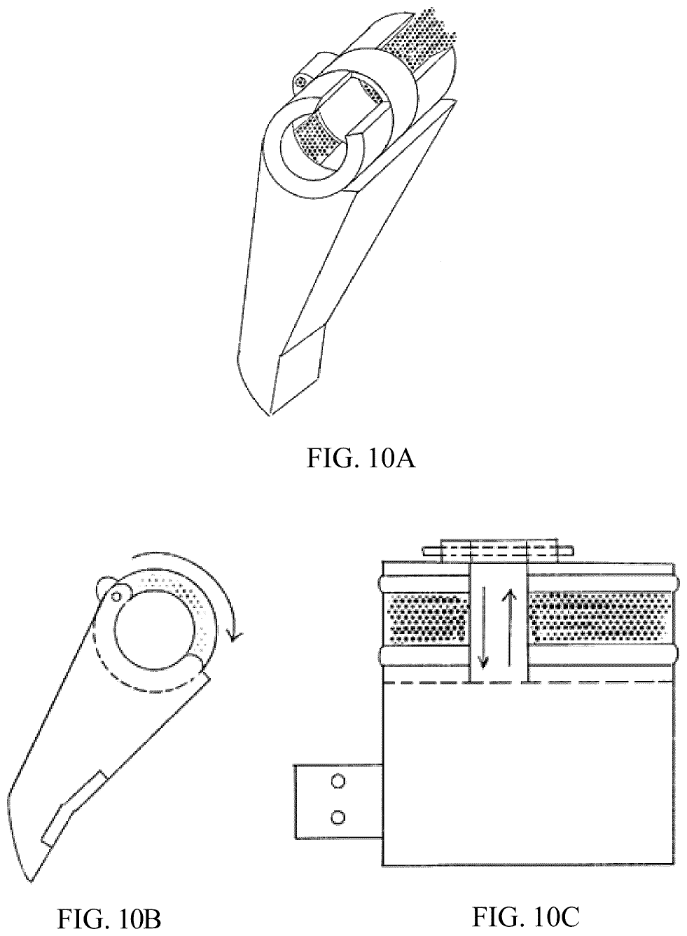

FIGS. 9A-9C show a further locking mechanism of the storage system of the present application, which can be combined with any of the embodiments described herein. The locking mechanism may comprise a plurality of clasps arranged along the front and/or rear bracket, which are configured to be opened, to allow the storage rack to be inserted onto the rail, and close around the storage rack slide rail or tube once inserted onto the rail. In the locking mechanism shown in FIGS. 9A-9C, the lock comprises a rounded clasp, which when the lock is closed forms a circle profile with the profile of the rail bracket that encloses a portion of a rail or cylindrical tube of the storage rack. However, other shapes may be utilized where the rail is not cylindrical. Further in the embodiment shown in FIGS. 9A-9C, the lock is configured to rotate about an upper hinge connecting the top of a locking arm and the rail assembly and comprises a bottom locking mechanism to lock the arm in a closed arrangement. In FIG. 9A, the locking mechanism is a pin configured to be inserted through an opening in the rail assembly and the locking arm, but other locking mechanisms can be used. FIGS. 10A-10C illustrate a further embodiment of a locking element using a different locking mechanism than the pin, such as interlocking clamps.

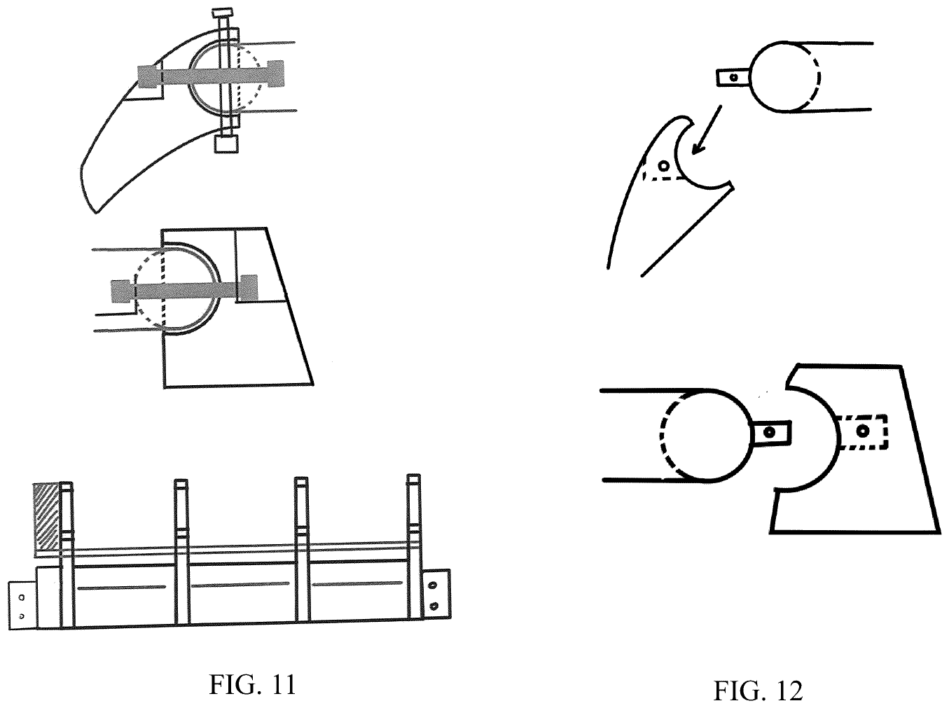

FIG. 11 illustrates a further embodiment of a mechanism for securing the storage rack to the front and rear bracket assemblies. In this embodiment, the end tubes of the storage rack and the front and rear bracket assemblies each comprise one or more overlapping through holes that are configured to receive a bold or screw passing through both the rail assembly and the tube, which secures the tube to the rail assembly. The through holes can be arranged horizontally and/or vertically along the length of the tubes and rail assemblies.

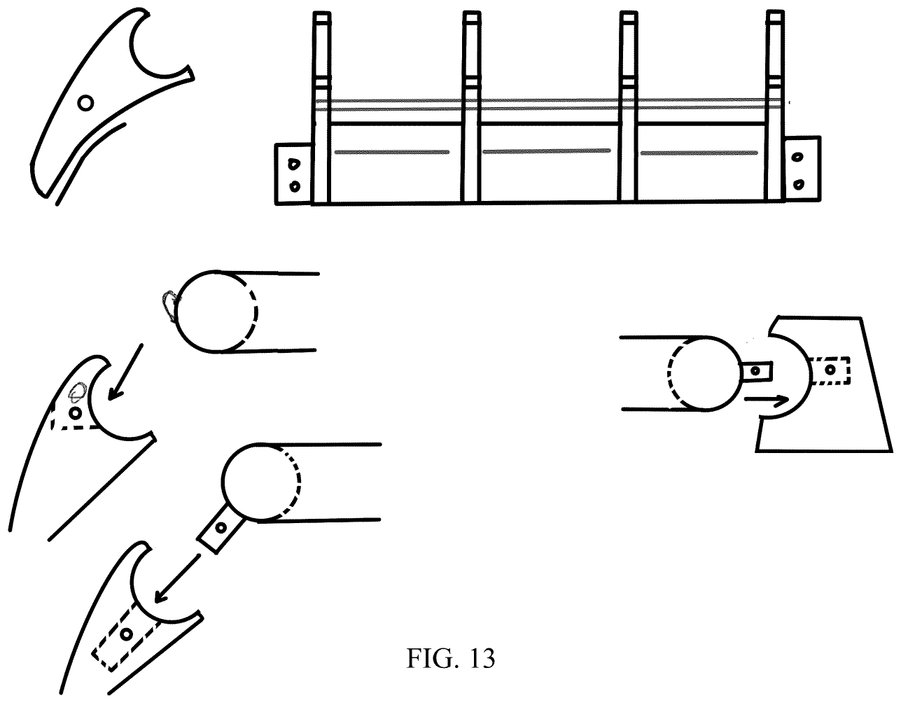

FIGS. 12 and 13 illustrate still further embodiments of mechanisms for securing the storage rack to the front and rear bracket assemblies. In these configurations, the tubes on the ends of the storage rack comprise one or more flanges along their length, which are configured to be received in corresponding brackets in the front and rear bracket assemblies. The front and rear bracket assemblies may comprise additional components used in locking the flanges corresponding to elements on the flanges, such as a hitch lock, dimples or projections to snap the flanges in place, openings to receive pins, magnetic elements, and/or tabs.

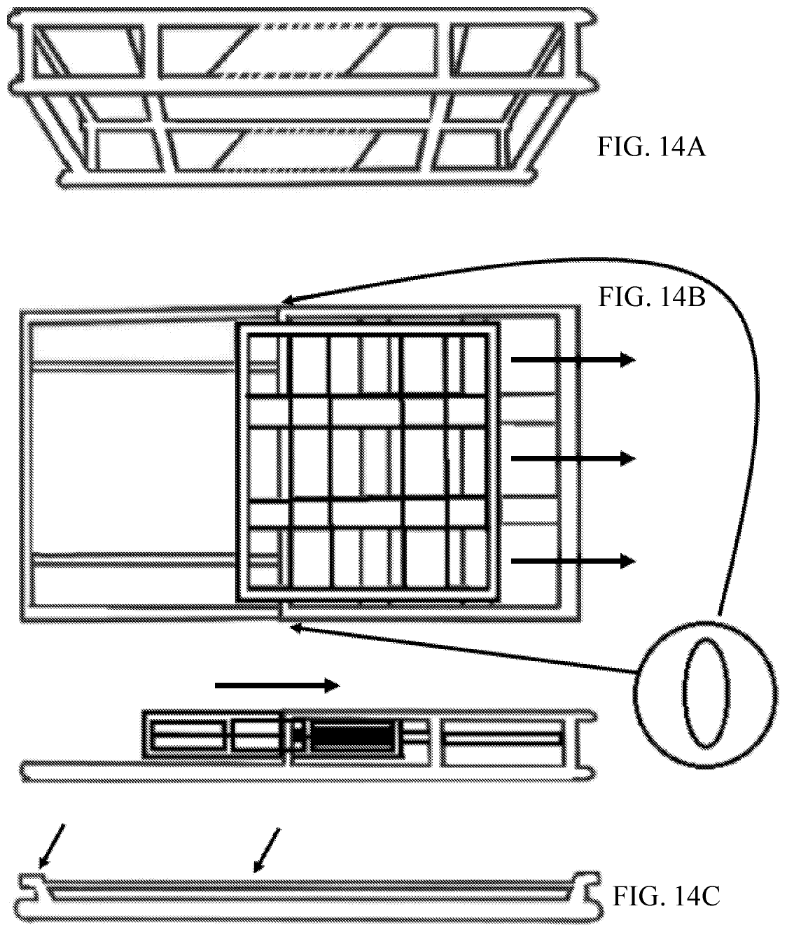

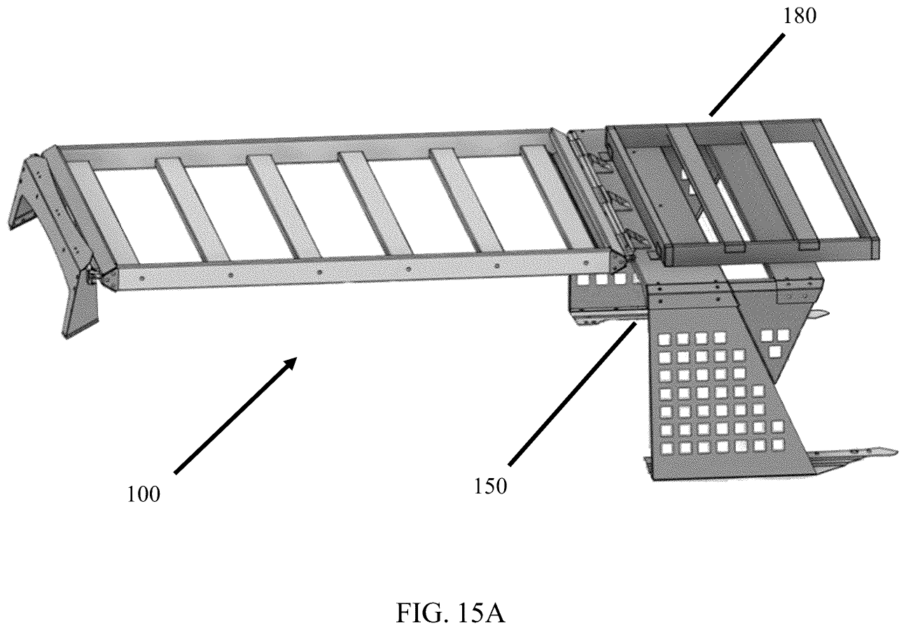

FIGS. 14A-14C show variations of the configuration of the storage rack of the storage system. FIG. 14A shows an embodiment of the storage rack having elevated rails to form a wall around the base, as previously described.

FIG. 14B illustrates an alternative embodiment of the storage rack, in which a storage base is provided, which is secured to the front and rear assemblies in any of the manners previously described. The storage rack further comprises a storage compartment that is configured to be slid across the storage base, as shown in the Figures. The storage compartment may be slid longitudinally across the storage base (i.e., from the rear to the front of the vehicle, or vice versa). The storage base may comprise a walled section at one end comprising rails along which the storage compartment may slide and may further comprise spring loaded push locks to lock the storage compartment in place.

FIG. 14C illustrates an alternative embodiment of a storage rack configured for use in storing and transporting canoes, kayaks, and other aquatic vessels along with paddles.

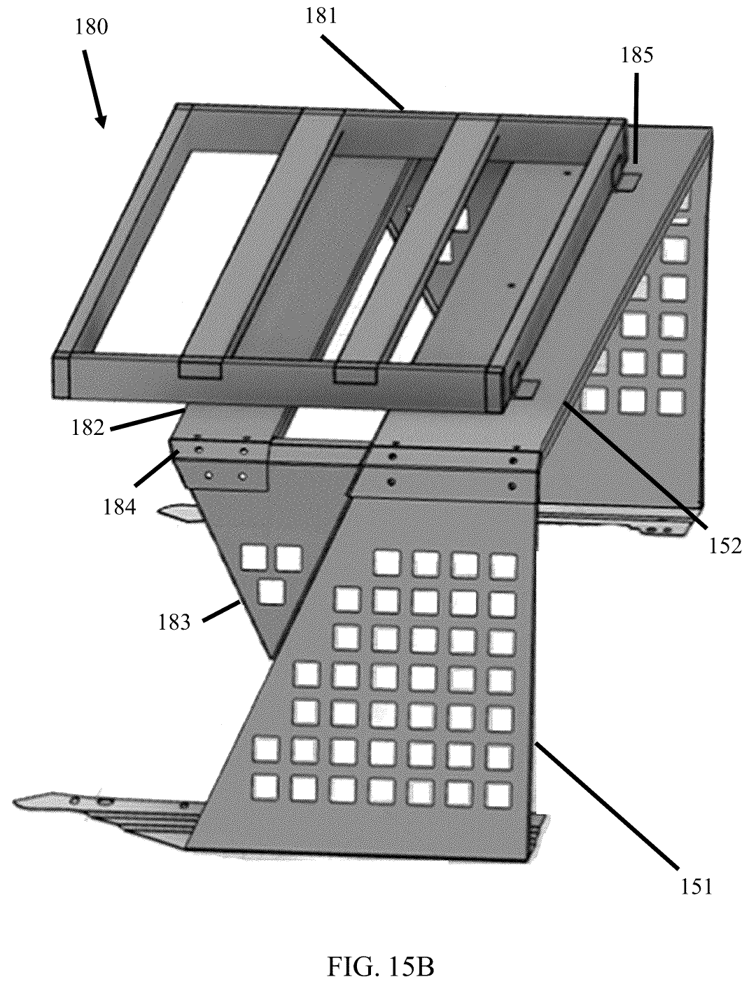

FIGS. 15A-15B show the roof rack storage system 100 of FIG. 2A further comprising a rear storage assembly 180 that can be attached to the rear bracket assembly 150. The rear storage assembly 180 provides additional flexibility by increasing the storage area available beyond the storage rack 130 provided in the roof rack storage system 100, for situations when additional storage may be required. The rear storage assembly 180 comprises a storage rack 181, which may comprise a structure similar to that of the storage rack 130, but having a shorter length. The rear storage assembly further comprises a cross rail 182 and towers 183, which can be connected by brackets 184, in a manner similar to the cross rail 152 and towers 151 of the rear bracket assembly 150. The storage rack 181 may be mounted to the cross rail 182 of the rear storage assembly 180, and additionally or alternatively, mounted to the cross rail 152 of the rear bracket assembly 150 by one or more mounting brackets 185. The mounting brackets 185 may comprise openings configured to align with through holes 161 in the cross rail 152 for receiving bolts or screws therethrough. The towers 183 of the rear storage assembly 180 may also be secured to the towers 151 of the rear bracket assembly 150. The rear storage assembly 180 is configured for easy removal from or attachment to the rear bracket assembly 150.

As used herein, directional, or positional terms such as “front”, “rear”, “upper”, “lower”, “top”, “bottom”, etc., are used for explanatory purposes only to describe the storage system 100 relative to the orientation of the vehicle 200 shown on the page for example in FIGS. 1A-1B.

While there have been shown and described and pointed out fundamental novel features of the invention as applied to embodiments thereof, it will be understood that various omissions and substitutions and changes in the form and details of the devices and methods described may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice.

What is claimed:

1. A system comprising:
a first bracket assembly comprising a first elongated bracket and configured to be mounted to a vehicle in a first location;
a second bracket assembly comprising a second elongated bracket and configured to be mounted to the vehicle in a second location;
a plurality of mounts configured to mount the second bracket assembly to the vehicle; and
a storage rack comprising a storage platform and a rail on each longitudinal end of the storage platform, including a first rail configured to engage the first elongated bracket and a second rail configured to engage the second elongated bracket.

2. The system according to claim 1, wherein first bracket assembly is configured to be mounted towards a front end of the vehicle and the second bracket assembly is configured to be mounted towards a rear end of the vehicle, and
wherein the first elongated bracket is configured to be disposed on a roof of the vehicle towards the front end of the vehicle, and the second elongated bracket is configured to be disposed on the roof of the vehicle towards the rear end of the vehicle.

3. The system according to claim 2, wherein the second bracket assembly comprises:
two towers, each of the towers comprising a base comprising one or more mounting elements; and
a cross rail disposed atop of and spanning the two towers and comprising the second elongated bracket mounted thereon.

4. The system according to claim 3, wherein each of the plurality of mounts comprises:
an inner segment comprising a plurality of mounting holes configured to receive bolts or screws configured to mount the inner segment to the vehicle; and
an outer segment comprising a plurality of further mounting holes configured to receive bolts or screws configured to mount the outer segment to one of the towers of the second bracket assembly.

5. The system according to claim 4, wherein each of the plurality of mounts further comprises a center segment comprising one or more steps configured to offset the inner segment and the outer segment in height.

6. The system according to claim 1, wherein the first bracket assembly comprises:
a fairing comprising an elongated section and a plurality of legs extending from the elongated section; and
a plurality of fairing brackets comprising a fairing bracket arranged on each end of the fairing adjacent to one of the plurality of legs, each of the fairing brackets comprising a base configured to mount to the vehicle, and a cutout configured to receive a portion of the first bracket.

7. The system according to claim 1, wherein the storage rack comprises two opposing longitudinal beams and a plurality of cross beams arranged in between and perpendicular to the longitudinal beams, the longitudinal beams and the plurality of cross beams defining the storage platform of the storage rack.

8. The system according to claim 7, wherein the storage rack further comprises a storage rack fairing arranged on each longitudinal end disposed in between the rail and the storage platform.

9. The system according to claim 1, wherein each rail of the storage rack comprises a plurality of rails arranged adjacently.

10. The system according to claim 1, wherein each of the rails of the storage rack are configured to slide laterally within the first bracket and the second bracket to permit lateral movement of the storage rack.

11. The system according to claim 10, wherein the first bracket and the second bracket each comprise a stop member at one end to prevent lateral movement of the storage rack past the stop member.

12. The system according to claim 1, wherein the each of the rails of the storage rack are cylindrical tubes and the first and second brackets are each configured to receive the cylindrical tubes.

13. The system according to claim 12, wherein the each of the rails of the storage rack are configured to snap into the first and second bracket to engage the rails within the first and second bracket.

14. The system according to claim 3, wherein the cross rail comprises a plurality of through holes configured to receive bolts or screws configured to mount the second rail to the cross rail.

15. The system according to claim 1, wherein the storage rack further comprises a vertical barrier on a plurality of sides of the storage platform to contain objects on the storage platform within the vertical barriers.
